(19) United States
(12) Patent Application Publication
(10) Pub. No.: US 2013/0117578 A1
(43) Pub. Date: May 9, 2013

(54) METHOD FOR VERIFYING A MEMORY BLOCK OF A NONVOLATILE MEMORY

(71) Applicants: Markus Ihle, Kusterdingen (DE); Oliver Bubeck, Pluederhausen (DE); Jamshid Shokrollahi, Ludwigsburg (DE); Jan Hayek, Muenchen (DE)

(72) Inventors: Markus Ihle, Kusterdingen (DE); Oliver Bubeck, Pluederhausen (DE); Jamshid Shokrollahi, Ludwigsburg (DE); Jan Hayek, Muenchen (DE)

(21) Appl. No.: 13/581,794

(22) PCT Filed: Feb. 7, 2011
(86) PCT No.: PCT/EP2011/051714

§ 371 Date: Jan. 22, 2013

(30) Foreign Application Priority Data
Mar. 1, 2010 (DE) 102010002472.4

(51) Int. Cl. G06F 12/14

(52) U.S. Cl. 713/193

(57) ABSTRACT

In a method for verifying a memory block of a nonvolatile memory, at a first point in time, a first authentication code for the memory block is determined while using a secret keyword and is stored in an authentication code memory table, and at a second point in time, for the verification, a second authentication code for the memory block is determined while using the secret keyword and is compared to the first authentication code and the memory block is verified if the first authentication code and the second authentication code agree.

### BACKGROUND OF THE INVENTION

1. Field of the Invention

The present invention relates to a method for verifying a memory block of a nonvolatile memory.

2. Description of the Related Art

The present invention may be used to detect non-authorized manipulations of certain memory blocks, particularly of a nonvolatile block (NVM, nonvolatile memory). The present invention is particularly suitable for verifying memory blocks of arithmetic units, such as embedded systems, control units and the like, which are used for secure applications. Such memory blocks include, for instance, program codes for carrying out functionalities that are relevant to security or critical to security, or public keys which are used in asymmetrical cryptography methods, so that the authenticity of these memory blocks has to be backed up before their recognition and use.

It is known that one may use hash functions to verify such memory blocks. In this context, at first one hash value is calculated for each memory block that is to be verified, and is filed in a special memory area that is secure from manipulation. During the later verification, a hash value of the memory block is determined again and compared to the stored value. If the two values agree, it is able to be established that the memory block is intact. Such techniques are used, for example, in TPM's (trusted platform modules).

What is disadvantageous in the known method is that for each hash value of a memory block that is to be verified, a memory area has to be provided that is secure from manipulation. As a result, a relatively large memory area has to be provided, which is comparatively costly. By “secure memory area” one should understand a memory area that is not recordable to third parties.

It is therefore desirable to state a method sparing of resources for verifying a memory block of a nonvolatile memory.

### BRIEF SUMMARY OF THE INVENTION

The present invention makes use of the measure of determining the authentication codes, particularly MAC (message authentication code) for the memory blocks that are to be verified. In this context, the present invention uses a secret keyword or secret key, so that the magnitude of the secure memory area, that is to be provided, is restricted essentially to being able to pack the secret keyword. The secret keyword is stored in the secure memory area in such a way that it is not accessible from the outside, and is particularly not able to be read out. The verification takes place completely and automatically within the arithmetic unit. In the related art, known hash functions are used, so that the hash value for a memory block is, in principle, determinable by anybody. As a result, the hash values have to be stored so securely that manipulations are excluded. However, in the present invention, a secret keyword is used, so that the calculated authentication codes, which are comparable to hash values, are specifically not determinable by everybody. As a result, the determined authentication codes are able to be stored at any place, especially even in non-secure memory areas. Only the keyword used is to be stored in a secure memory area. As a result, the requirement for a secure memory location is considerably reduced, which leads to simplification of the arithmetic unit, and to cost reduction.

Expediently, in the authentication code memory table, a memory address and a memory length of the memory block, that is to be verified, are stored in addition. Consequently, it may easily be checked to which memory block the stored authentication code belongs.

A memory address and a memory length of the authentication code storage table are preferably stored in an address memory block, so that the authentication code memory table is always adaptable to the momentary conditions, and no flexibility restrictions exist, for example, because of a permanently specified memory address and a memory length. The authentication code storage table may therefore also be provided particularly in the nonvolatile memory.

In a preferred embodiment, an authentication code for the authentication code memory table is also determined while using the secret keyword, and is stored in the address memory block. With that, the abovementioned flexibility is reached at the greatest manipulation security, since it may always be checked whether the actually correct authentication code memory table is used.

For the additional increase in the security, the address memory block is expediently provided in a secure memory area. By “secure memory area” one should understand a memory area that is not recordable to third parties.

In the embodiment, an electronic security module is used which has the secure memory area and which is equipped to determine the authentication code. Thus, in a simple manner, existing systems may also be retrofitted.

An arithmetic unit according to the present invention, such as a control unit of a motor vehicle, is equipped, particularly in a program technology manner, to carry out a method according to the present invention. In particular, it has the electronic security module just described.

The implementation of the method in the form of software is also advantageous, since this causes particularly low costs, especially if an executing control unit is also used for additional tasks and is therefore present anyway. Suitable data carriers for providing the computer program are, in particular, diskettes, hard disks, flash memories, EEPROMs, CD-ROM's, DVSD's and other similar ones. A download of a program via computer networks (Internet, intranet, etc.) is also possible

Further advantages and embodiments of the present invention are derived from the description and the accompanying drawings.

It is understood that the features mentioned above and the features yet to be described below may be used not only in the combination given in each case but also in other combinations or individually, without departing from the scope of the present invention.

The present invention is represented schematically in the drawing in light of an exemplary embodiment, and is described in detail below with reference to the drawings.

### BRIEF DESCRIPTION OF THE DRAWINGS

FIG. 1 shows a block diagram of a specific embodiment of an arithmetic unit according to the present invention.

FIG. 2 shows a flow chart of a part of a specific embodiment of a method according to the present invention taking place at a first point in time.

FIG. 3 shows a flow chart of a part of a specific embodiment of a method according to the present invention taking place at a second point in time.

### DETAILED DESCRIPTION OF THE INVENTION

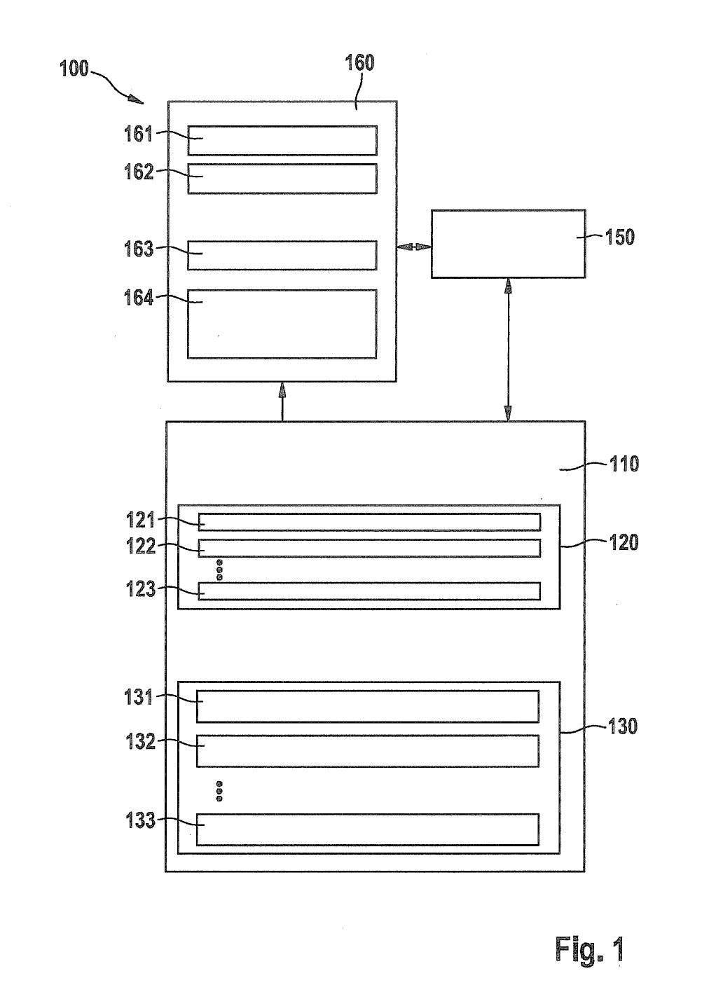

FIG. 1 shows schematically a preferred specific embodiment of an arithmetic unit according to the present invention in a block diagram and indicated as a whole by 100. Arithmetic unit 100 includes, besides additional components not shown, such as a CPU, a RAM, etc., three components 110, 150 and 160, which contribute to the realization of the present invention in the preferred specific embodiment shown, and which will be explained in sequence below.

Arithmetic unit 100 has a nonvolatile memory (NVM) 110, in which memory blocks 131, 132, etc., that are to be verified, are stored. This may be, for instance, components of a firmware, keywords, or the like, so that the authenticity of the memory blocks should be secure. In nonvolatile memory 110, an authentication code memory table 120 having individual table area 121, 122, etc., is stored.

Arithmetic unit 100 also includes a writing module 150, which is in a position to write on nonvolatile memory 110. Writing module 150 may be a part of the CPU or an external part. Furthermore, arithmetic unit 100 includes an electronic security module 160 which is responsible for carrying out the encryption operations and provides a secure memory area. Secure module 160 includes a secure memory area 161 that is not readable to third parties, in which a secret keyword is stored for generating authentication codes. Moreover, security module 160 includes a secure memory area 162 for packing an address memory block, in which an authentication code for authentication code memory table 120, a memory address and a memory length are stored. Security module 160 also includes a processing module 163 as well as, optionally, a coprocessor 164 for speeding up symmetrical encryptions.

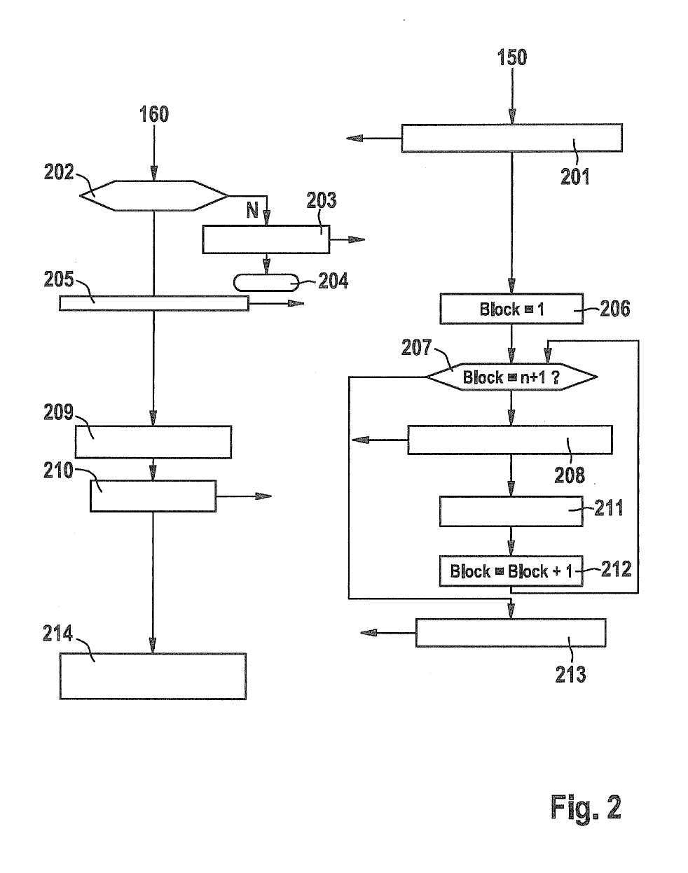

FIG. 2 describes a part of a specific embodiment of the method according to the present invention, that is to be carried out at a first point in time, which is used to generate authentication codes.

In a step 201, write module 150 first acknowledges to security module 160, while using any desired authentication method, that write module 150 is authorized to write on nonvolatile memory 110.

In a step 202, security module 160 checks whether the authentication is successful. If the authentication is not successful, security module 160, in a step 203, sends a corresponding message to write module 150, and terminates the method in a step 204.

If, on the other hand, the authentication is successful, security module 160 sends a corresponding message of success to write module 150 in a step 205.

Subsequently, write module 150 begins in a step 206 with the first block to be secured, that is, numeral 131 according to FIG. 1, and in a step 207, checks whether the last block to be secured has been reached. If this is not the case, write module 150 transmits the memory address and the memory length of the respective block to security module 160 in a step 208.

In a step 209, security module 160 reads the respective memory block from nonvolatile memory 110 and, with the aid of the keyword stored in secure memory area 161, calculates the associated authentication code. The latter is transmitted in a step 210 to write module 150, which writes the authentication code in a step 211 together with the memory address and the memory length of block 131 to authentication code memory table 120, in this case, in table area 121.

In a subsequent method step 212, the next block is selected, and the method returns to step 207. After the correspondingly frequent carrying out of the method in step 207, if it is determined that the last block n has been processed, in a step 213 the memory address and the memory length of authentication code memory table 120 are transmitted to security module 160 which, subsequently, in a step 214, calculates the authentication code for authentication code memory table 120, and stores it, together with the memory address and the memory length, in secure memory area 162.

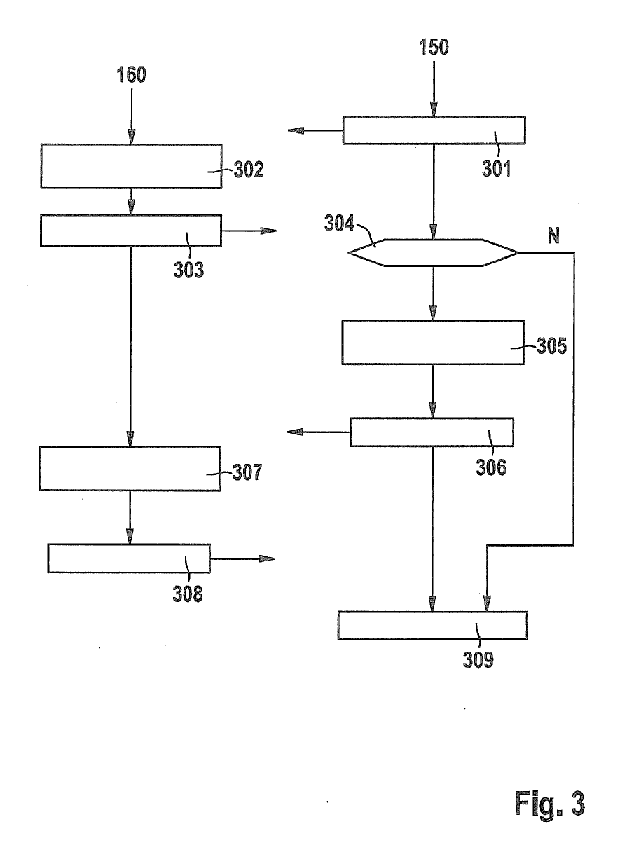

A verification of memory blocks 131, to be carried out during the operation, will be explained below, with reference to FIG. 3.

In a step 301, write module 150 requests security module 160 to verify authentication code memory table 120.

Thereupon, in a step 302, security module 160 calculates the authentication code for authentication code memory table 120, whose position and length it is able to read from memory area 162, and compares the calculated value to the value also stored in memory area 162. The result of the comparison is supplied by security module 160, in a method step 303, to write module 150, which, in a step 304, evaluates the result. If the authentication codes do not agree with each other, the result is transmitted to an entity 309, which makes a decision based on the result of the comparison.

However, if the authentication codes agree, write module 150, in a step 305, reads the memory address, the memory length and the authentication code of the memory block to be verified from authentication code memory table 120. For example, it reads table area 122 when block 132 is to be verified.

In a step 306, write module 150 transmits these data to security module 160 which, in a step 307, with the aid of the data, reads out from the corresponding memory block, for example 132, in nonvolatile memory 110, and calculates its authentication code. Subsequently, security module 160 compares the newly calculated authentication code to the authentication code transmitted by write module 150, and transmits the result of the comparison to write module 150 in a step 308.

Write module 150, in a step 309, then makes an appropriate decision based on the result of the comparison.

Using the present invention, makes it possible to verify memory blocks, and to keep the needed requirements for this, for secure memory, low.

1-9. (canceled)

10. A method for verifying a memory block of a nonvolatile memory, comprising:
determining, at a first point in time, a first authentication code for the memory block by using a secret keyword, and storing the first authentication code in an authentication code memory table;
determining, at a second point in time, a second authentication code for the memory block by using the secret keyword;
comparing the second authentication code to the first authentication code, wherein the memory block is verified if the first authentication code and the second authentication code agree.

11. The method as recited in claim 10, wherein the authentication code memory table additionally includes a memory address and a memory length of the memory block.

12. The method as recited in claim 11, wherein the memory address and the memory length included in the authentication code memory table are stored in an address memory block.

13. The method as recited in claim 12, further comprising:
determining a third authentication code for the authentication code memory table by using the secret keyword, and storing the third authentication code in the address memory block.

14. The method as recited in claim 12, wherein the address memory block is provided in a secure memory area.

15. The method as recited in claim 13, wherein the secret keyword is stored in a secure memory area which is not accessible to unauthorized parties.

16. The method as recited in claim 12, wherein the authentication code memory table is provided in a nonvolatile memory.

17. The method as recited in claim 15, wherein the secure memory area is provided in an electronic security module which is configured to determine the first, second and third authentication codes.

18. An arithmetic unit configured for verifying a memory block of a nonvolatile memory, comprising:
means for determining, at a first point in time, a first authentication code for the memory block by using a secret keyword, and storing the first authentication code in an authentication code memory table;
means for determining, at a second point in time, a second authentication code for the memory block by using the secret keyword;
means for comparing the second authentication code to the first authentication code, wherein the memory block is verified if the first authentication code and the second authentication code agree.
